(19) United States
(12) Patent Application Publication
(10) Pub. No.: US 2011/0303346 A1
(43) Pub. Date: Dec. 15, 2011

(54) METHOD FOR JOINING SHEETS TO FORM AN ELECTRO-OPTICAL COMPONENT

(76) Inventor: Chak Seng LEUNG, Hong kong (HK)

(21) Appl. No.: 13/086,877

(22) Filed: Apr. 14, 2011

(30) Foreign Application Priority Data
Jun. 10, 2010 (HK) 10105828.5

(51) Int. Cl. B29C 65/14

(52) U.S. Cl. 156/87

(57) ABSTRACT

A method for joining sheets (20, 30) to form an electro-optical component, the method comprising: sealing a substantial peripheral portion of the sheets (20, 30) together leaving only an aperture (41) for access to a space defined between the sheets (20, 30); removing air between the sheets (20, 30) via the aperture (41) to create a vacuum between the sheets (20, 30); and filling the vacuum created between the substantially sealed sheets (20, 30) with an adhesive introduced via the aperture (41).

### TECHNICAL FIELD

The invention concerns a method for joining sheets to form an electro-optical component.

### BACKGROUND OF THE INVENTION

Existing assembly processes for capacitive touch panel displays are inefficient. Rework is labour consuming when the manufactured product is not of adequate quality, leading to poor product yield, and higher production cost. Also, high equipment investment is required for these existing assembly processes.

Currently, two rigid transparent electro-optical components such as capacitive touch panels are attached together with aid of optical pressure sensitive adhesive. They may also be commonly referred to as Optical Clear Adhesive for Capacitive Touch Screens or liquid adhesive applied on one plate. The other plate is placed onto the adhesive covered plate. In the situation where liquid adhesive is used, this causes the adhesive to spread out, sometimes unevenly, between the plates when pressure is applied to push the plates together. Also, air bubbles are usually observed between the plates afterwards. This results in rework, poorer yield, low efficiency, higher cost, high labour consumption and high investment for manufacturing equipment.

Accordingly, there is a desire for a method of assembling touch panel displays that ameliorates at least some of the abovementioned problems.

### SUMMARY OF THE INVENTION

In a first preferred aspect, there is provided a method for joining sheets to form an electro-optical component, the method comprising:
sealing a substantial peripheral portion of the sheets together leaving only an aperture for access to a space defined between the sheets;
removing air between the sheets via the aperture to create a vacuum between the sheets; and
filling the vacuum created between the substantially sealed sheets with an adhesive introduced via the aperture.

The method may further comprise curing the adhered sheets.

The adhesive may be filled between the substantially sealed sheets according to any one from the group consisting of: dipping the sheets into a reservoir of adhesive such that the adhesive flows between the sheets via the aperture, connecting the aperture and adhesive via a capillary material such that the adhesive flows from reservoir of adhesive to between the sheets via the capillary material and the aperture, and injecting the adhesive between the substantially sealed sheets via the aperture using a detachable adapter.

More than one aperture may be provided for access to the space between the substantially sealed sheets and more than one adapter is used to inject adhesive between the substantially sealed sheets, if the sheets are greater than a predetermined size.

Air may be removed between the substantially sealed sheets using an air suction device.

The air suction device may be releasably attachable to the adapter

The sheets may be made of glass and/or plastic.

The curing may be performed thermally, by infrared radiation, or by ultraviolet radiation.

The electro-optical component may be a touch screen or TFT LCD screen.

If the sheets are different sizes, a substantial peripheral portion of a smaller sheet may be sealed to a larger sheet such that only an aperture for access to the space defined between the sheets remains.

In a second aspect, there is provided a system for joining sheets to form an electro-optical component, the system comprising:
a sealant to seal a substantial peripheral portion of the sheets together leaving only an aperture for access to a space defined between the sheets;
an air suction device to remove air between the sheets via the aperture to create a vacuum between the sheets; and
liquid adhesive to fill the vacuum created between the substantially sealed sheets via the aperture.

In a third aspect, there is provided an adapter for joining sheets to form an electro-optical component, the adapter comprising:
a body portion; and
a hollow tube extending from the body portion to be inserted into an aperture defined in a sealant between two sealed sheets;
wherein air is removed between the two sealed sheets via the adapter and liquid adhesive is transferred into the two sealed sheets via the adapter.

### BRIEF DESCRIPTION OF THE DRAWINGS

An example of the invention will now be described with reference to the accompanying drawings, in which:

FIG. 1 is a perspective view of two sheets for producing an electro-optical component in accordance with an embodiment of the present invention;

FIG. 2 is a perspective view of the two sheets of FIG. 1 with peripheral sealant applied on a lower sheet of the two sheets;

FIG. 3 is a perspective view of the two sheets of FIG. 1 placed against each other with the sealant therebetween;

FIG. 4 is a front view of the of the two sheets of FIG. 1 placed against each other with the sealant therebetween

FIG. 5 is a perspective view of the two sheets of FIG. 1 with a filling adapter inserted into an aperture defined in the peripheral sealant;

FIG. 6 is a perspective view of two sheets showing multiple adapters prior to connection with apertures defined in the peripheral sealant;

FIG. 7 is a perspective view of two sheets with multiple adapters connected to the apertures defined in the peripheral sealant;

FIG. 8 is a top view of the filling adapter;

FIG. 9 is a side view of the filling adapter; and

FIG. 10 is a process flow diagram of a method for joining sheets to form an electro-optical component in accordance with an embodiment of the present invention.

### DETAILED DESCRIPTION OF THE DRAWINGS

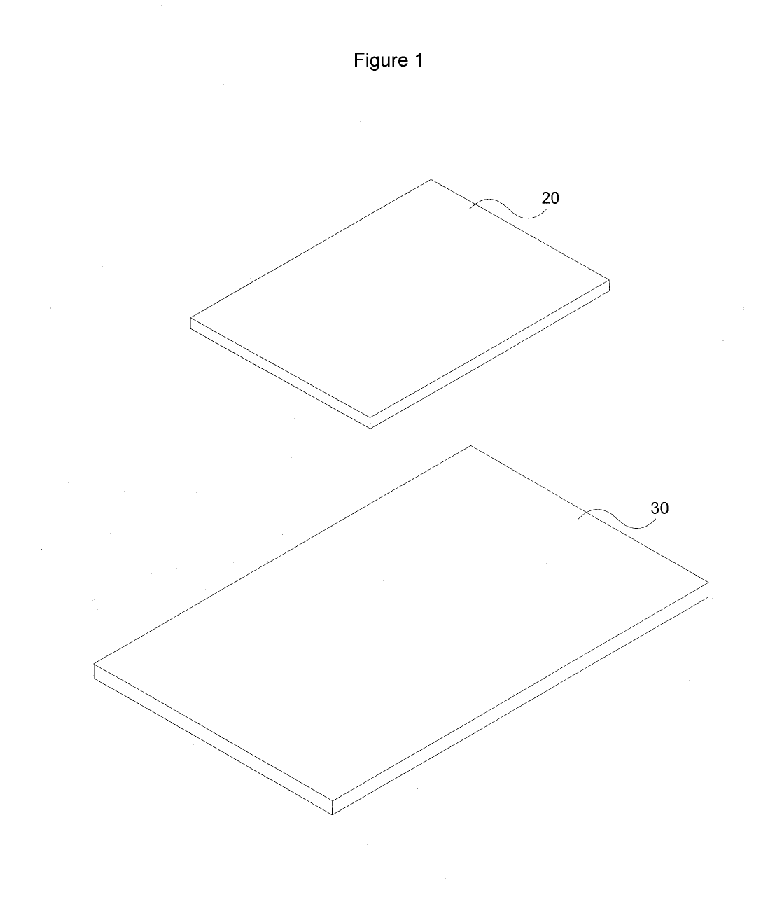

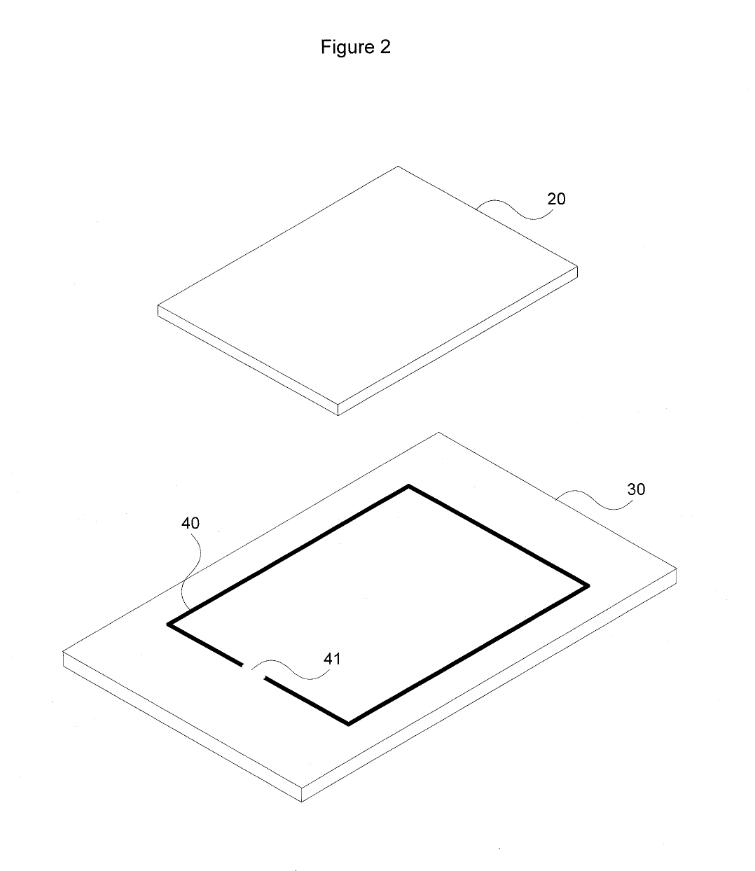

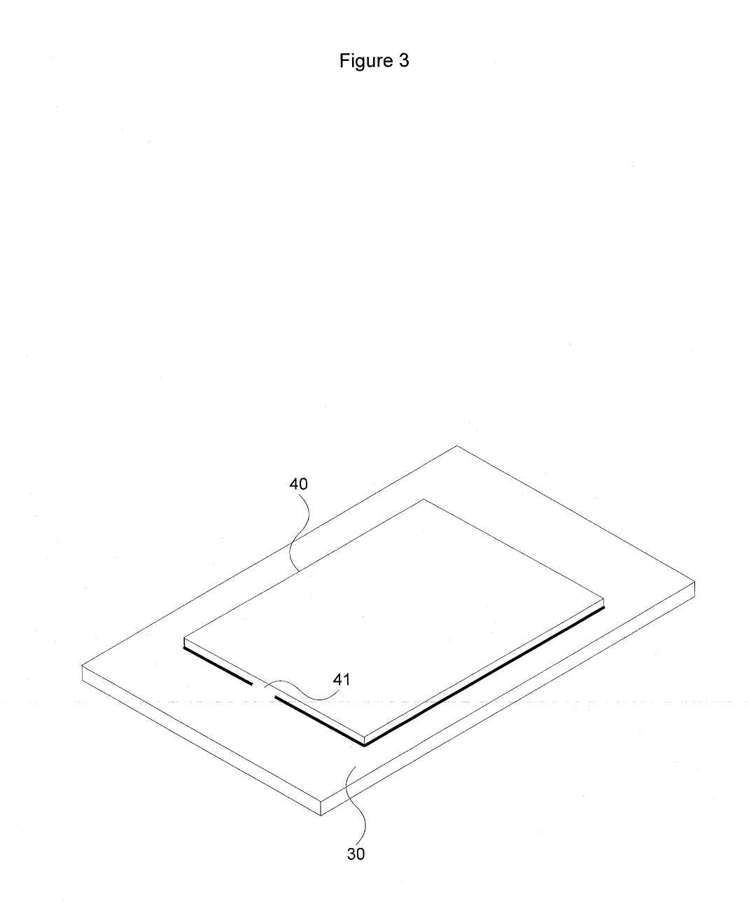

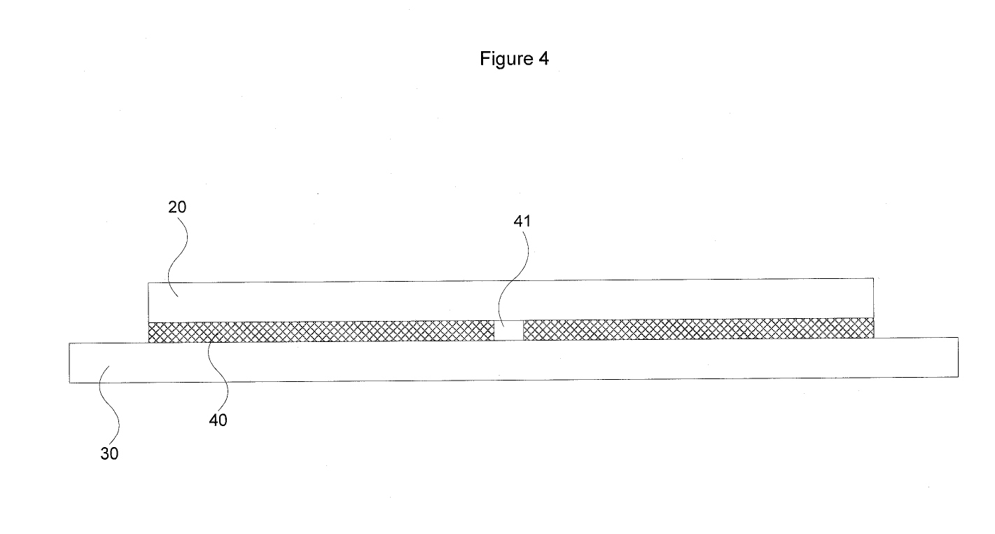

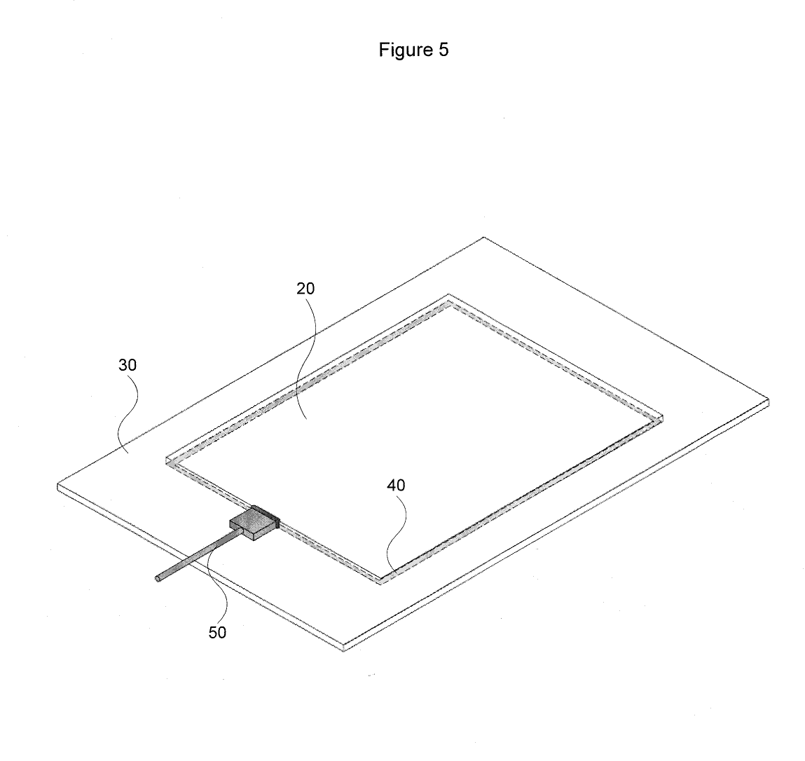

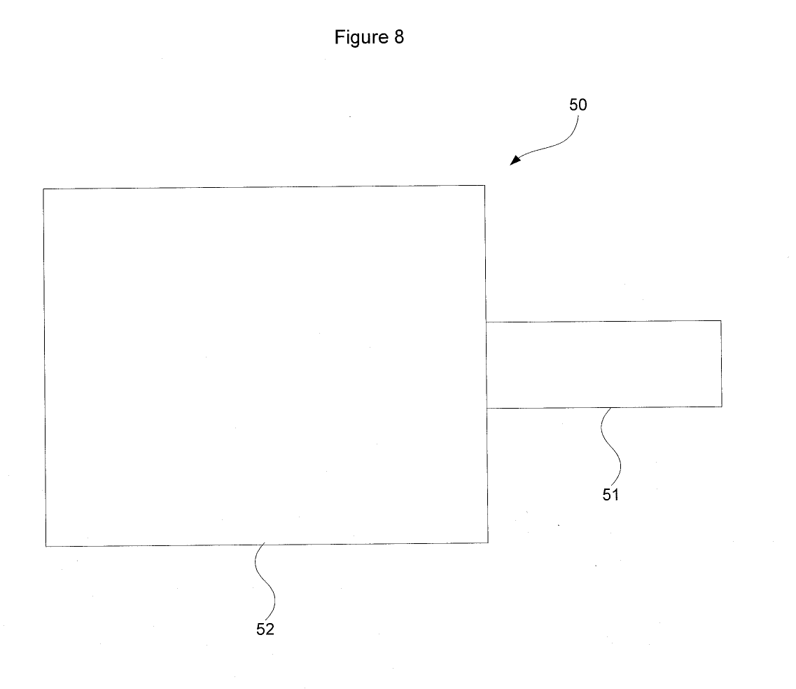

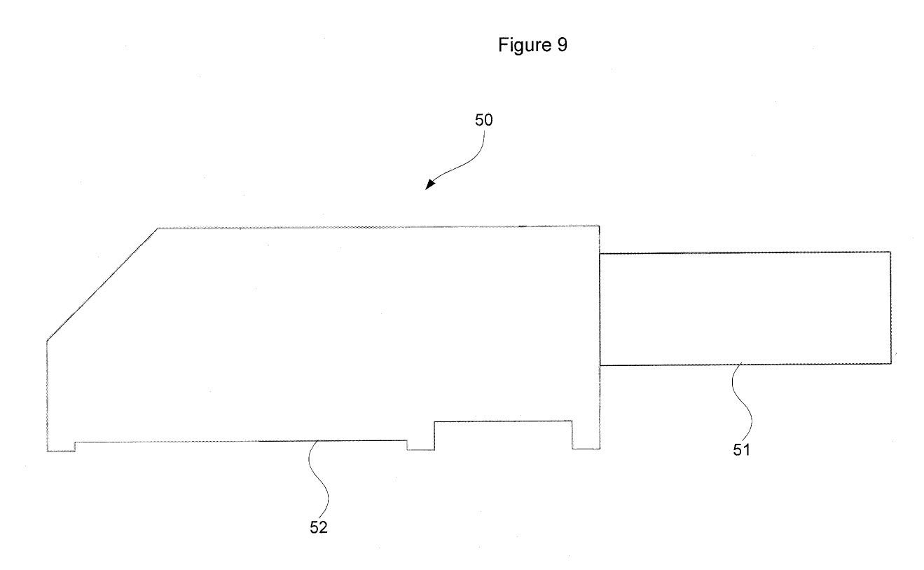

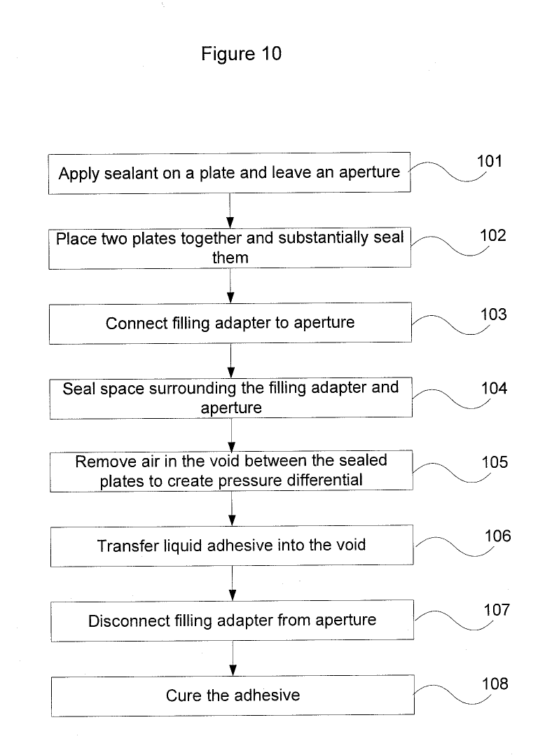

Referring to FIGS. 1 to 5, and 8 to 10, at least two electro-optical plate components 20, 30 are adhered together without resulting in any cosmetic and functional defects. The electro-optical plate components 20, 30 may be transparent sheets. The transparent sheets may be made from glass and/or plastic. One of the sheets may be referred to as the lens and the other as the sensor. Typically, the electro-optical component produced is used for capacitive touch screens and TFT LCD screens. Higher production yield, lower labour consumption, elimination of rework, higher throughput time and a lower investment in expensive machinery results when there is an absence of defects in the electro-optical components that are produced.

A controllable spacing sealant 40 is applied (101) on one of the two sheets 20, 30, typically, the lower sheet 30 that is beneath the upper sheet 20. In one embodiment, the sealant 40 is applied so it corresponds to the peripheral edge of the smaller sheet 20. Generally, the sealant 40 must provide a peripheral seal between the sheets 20, 30 leaving an aperture 41 for access to a narrow gap that exists between the sheets 20, 30. Spacer powder or spacer particles with a predetermined size is mixed into the peripheral sealant 40. After the sealant 40 is applied on one of the sheets 20, 30, the two sheets 20, 30 are slightly pressed together. A gap is formed with a slight height and the height is predetermined due to the predetermined size of the spacer powder or spacer particles in the sealant 40.

In one embodiment, the aperture 41 is located in the middle of a lateral side of the sealant 40. Next, the sheets 20, 30 are joined (102) together. The planar surfaces of the sheets 30 are slightly spaced apart due to the existence of the sealant 40 in between the peripheral edges of the sheets 20, 30. The connection between the sheets 20, 30 via the sealant 40 fixes them relative to each other.

A detachable filling adapter 50 is connected (103) to the aperture 41. The adapter 50 comprises a hollow tube 51 and tunneled body 52. The adapter 50 provides a fluid conduit from the external environment to the gap between the planar surfaces of the sheets 20, 30. The space surrounding the adapter 50 and the aperture 41 is sealed (104) with glue to prevent air leakage from this area. Access to the gap between the planar surfaces of the sheets 20, 30 is restricted to only via the adapter 50. In another embodiment, instead of using glue, a soft joint or double sided adhesive may be used to prevent from air leakage via the space surrounding the adapter 50 and the aperture 41.

Preferably, the adapter 50 has the dimensions of length 10 mm, width 8 mm and height 4 mm. The exposed outer tube 51 extends within the housing 52 of the adapter to become an inner tube. The inner tube redirects downwards where it receives the liquid adhesive from a reservoir. The inner tube may be of various shapes, lengths and forms. The flow rate is dependent on the difference in pressure between the ambient pressure and the pressure in the gap between the sheets 20, 30. So long as pressure difference is not zero , there is adhesive flow. After the gap is completely filled adhesive, there is no pressure difference, and the adhesive flow ceases.

Air contained in the gap between the planar surfaces of the sheets 20, 30 is removed (105) using a vacuum pump or air suction device connected to the distal end of the adapter 50. After the air has been removed, liquid glue is transferred (106) into the gap between the planar surfaces of the sheets 20, 30 via the adapter. For example, the distal end of the adapter 50 may be dipped in an adhesive reservoir. The pressure outside the gap is adjusted to be higher than the pressure within the gap. This pressure differential forces the flow of adhesive liquid into the gap.

After the liquid glue has been fully transferred into the gap, the adapter 50 is detached (107) from the aperture 41. To ensure a sufficient amount of liquid adhesive has been transferred, the pressure difference between the gap defined in the sheets 20, 30 and the ambient pressure is relied upon. When the void between the sheets 20, 30 is completely filled with the adhesive, there will be no pressure difference which causes the adhesive transfer process to automatically cease.

The liquid glue transferred into the gap is cured (108) either thermally, by infrared radiation or by ultraviolet radiation. This results in the permanent adhesion of the sheets 20, 30 together which does not produce uneveness in the adhesive spread or cause the occurrence of air bubbles. This result is highly advantageous for the electro-optical industry in the area of capacitive touch panel.

In another embodiment, no adapter 50 is required. An intermediate member made of a capillary material is positioned at the aperture 41 and is in fluid connection with a liquid adhesive reservoir. Liquid adhesive from the liquid adhesive reservoir is directed into the gap between the planar surfaces of the sheets 20, 30 via the aperture 41. The capillary material may be a sponge, foam, or fibre tissue to conduct adhesive from the reservoir via the aperture 41 into the gap.

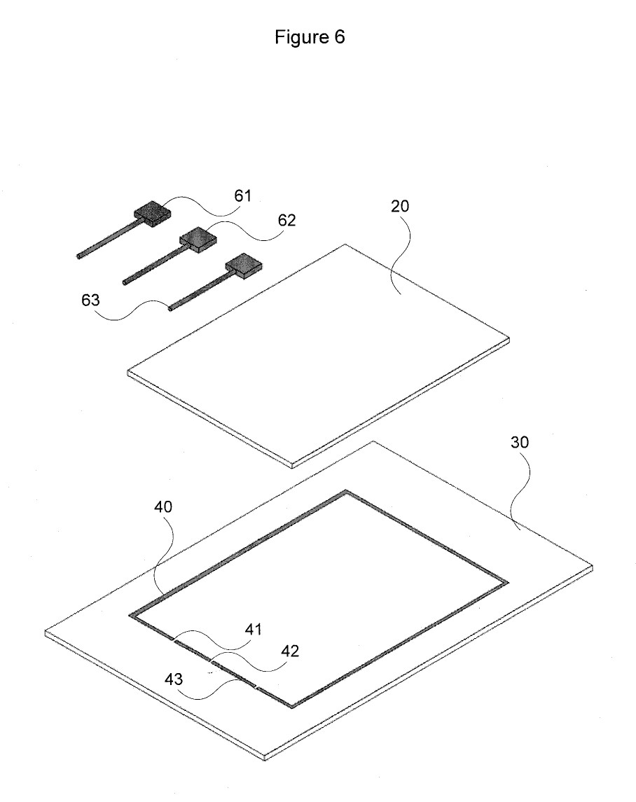

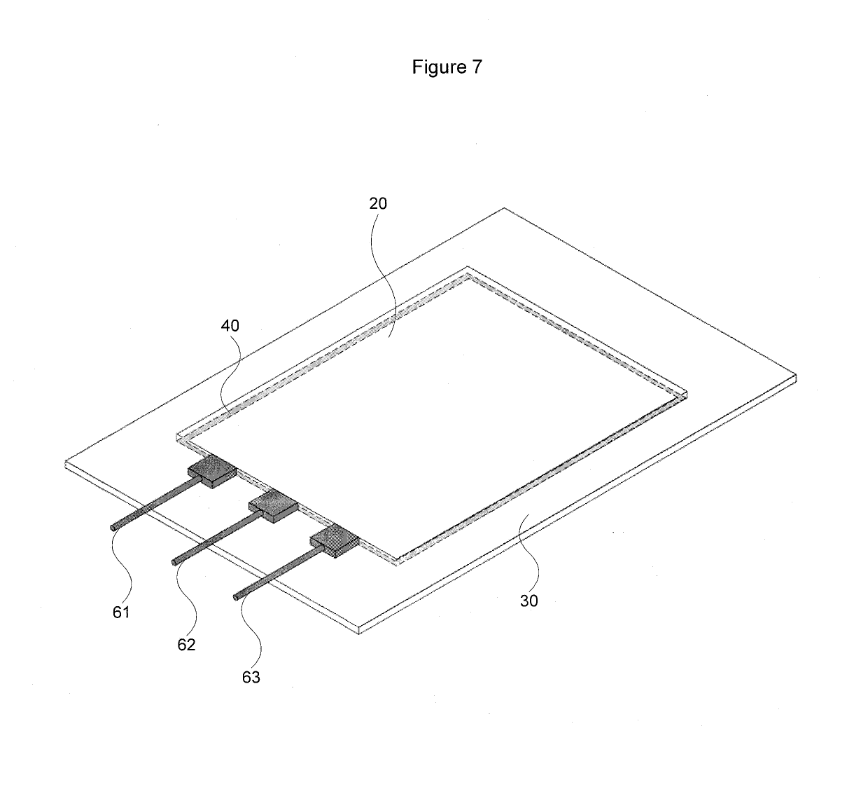

Referring to FIGS. 6 and 7, in another embodiment, multiple adapters 61, 62, 63 are used to shorten the production time and/or to handle larger sized sheets 20, 30. There are three apertures 41, 42, 43, in the sealant 40 to receive the adapters 61, 62, 63.

Although the sheets 20, 30 have been described as having different sizes, it is possible for the sheets 20, 30 to be the same size. Although the sheets 20, 30 have been described as having a rectangular shape, they may be of any shape. Although the sheets 20, 30 have been described as rigid, they may be non-rigid.

Although creation of a vacuum has been described, it is envisaged that as long as a pressure differential is created between the void in the space between the sheets 20, 30 and the ambient environment, the flow of liquid adhesive into the void is achieved.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for joining sheets to form an electro-optical component, the method comprising:
sealing a substantial peripheral portion of the sheets together leaving only an aperture for access to a space defined between the sheets;
removing air between the sheets via the aperture to create a vacuum between the sheets; and
filling the vacuum created between the substantially sealed sheets with an adhesive introduced via the aperture.

2. The method according to claim 1, further comprising curing the adhered sheets.

3. The method according to claim 1, wherein the adhesive is filled between the substantially sealed sheets according to any one from the group consisting of: dipping the sheets into a reservoir of adhesive such that the adhesive flows between the sheets via the aperture, connecting the aperture and adhesive via a capillary material such that the adhesive flows from reservoir of adhesive to between the sheets via the capillary material and the aperture, and injecting the adhesive between the substantially sealed sheets via the aperture using a detachable adapter.

4. The method according to claim 1, wherein more than one aperture is provided for access to the space between the substantially sealed sheets and more than one adapter is used to inject adhesive between the substantially sealed sheets, if the sheets are greater than a predetermined size.

5. The method according to claim 1, wherein air is removed between the substantially sealed sheets using an air suction device.

6. The method according to claim 5, wherein the air suction device is releasably attachable to the adapter

7. The method according to claim 1, wherein the sheets are made of glass and/or plastic.

8. The method according to claim 2, wherein the curing is performed thermally, by infrared radiation, or by ultraviolet radiation.

9. The method according to claim 1, wherein the electro-optical component is a touch screen or TFT LCD screen.

10. The method according to claim 1, wherein if the sheets are different sizes, a substantial peripheral portion of a smaller sheet is sealed to a larger sheet such that only an aperture for access to the space defined between the sheets remains.
